(19) United States
(12) Patent Application Publication
(10) Pub. No.: US 2010/0071656 A1
(43) Pub. Date: Mar. 25, 2010

(54) VALVETRAIN CONTROL STRATEGIES FOR EXHAUST AFTERTREATMENT DEVICES

(75) Inventors: Charles E. Freese, V, Ira Township, MI (US); Gary J. Arvan, Rochester Hills, MI (US)

Correspondence Address: Harness Dickey & Pierce, P.L.C., P.O. Box 828, Bloomfield Hills, MI, 48303, US

(73) Assignee: GM GLOBAL TCHNOLOGY OPERATIONS, INC., DETROIT, MI (US)

(21) Appl. No.: 12/237,909

(22) Filed: Sep. 25, 2008

(51) Int. Cl. F02D 17/02

(52) U.S. Cl. 123/198 F; 123/90.15; 60/287

(57) ABSTRACT

A method may include operating an engine in a first valvetrain mode during a first engine operating condition, operating the engine in a second valvetrain mode different from the first valvetrain mode during a second engine operating condition, and controlling a temperature of an exhaust aftertreatment component in communication with an exhaust gas from the engine during the second engine operating condition based on the second valvetrain mode.

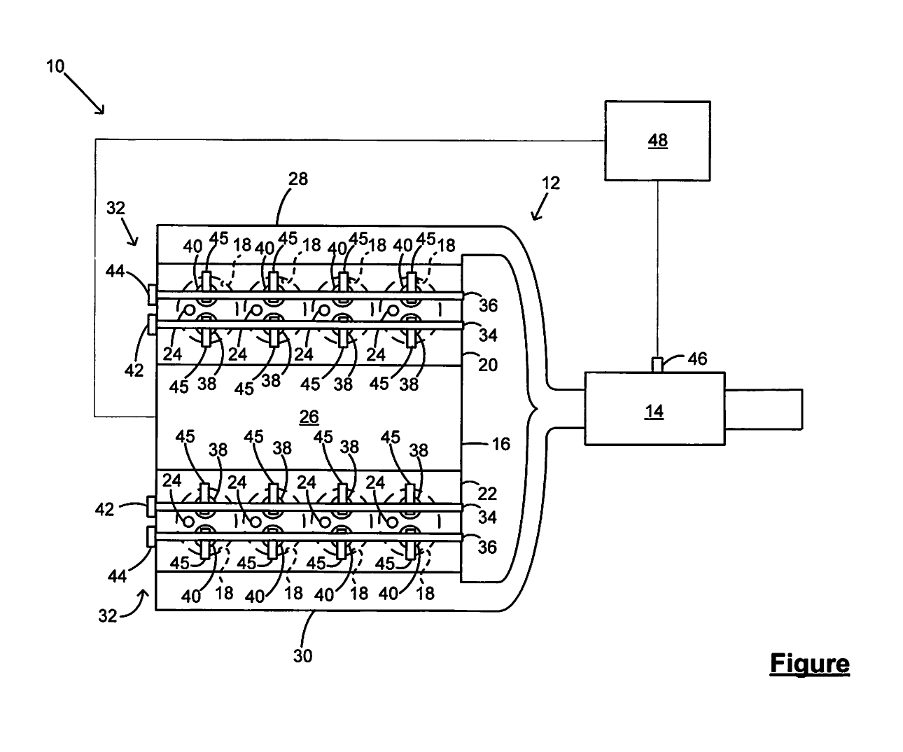

### FIELD

The present disclosure relates to exhaust aftertreatment devices, and more specifically valvetrain control strategies for exhaust aftertreatment devices.

### BACKGROUND

The statements in this section merely provide background information related to the present disclosure and may not constitute prior art.

Engine assemblies typically include an exhaust aftertreatment system in communication with an engine exhaust gas. The aftertreatment systems generally reduce an emissions level, either solid or gas, in the exhaust gas. The aftertreatment systems may require operation at a specific temperature before being capable of effectively reducing engine emissions. Additional components may be incorporated into the exhaust aftertreatment systems to maintain the necessary operating temperature, providing additional system cost and complexity.

### SUMMARY

A method may include operating an engine in a first valvetrain mode during a first engine operating condition, operating the engine in a second valvetrain mode different from the first valvetrain mode during a second engine operating condition, and controlling a temperature of an exhaust aftertreatment component in communication with an exhaust gas from the engine during the second engine operating condition based on the second valvetrain mode.

An engine assembly may include an engine, an exhaust aftertreatment system, and a control module. The engine may include a valvetrain operable in first and second modes. The exhaust aftertreatment system may be in communication with an exhaust gas provided by the engine and the control module may be in communication with the engine to control a temperature and/or gaseous constituents of the exhaust aftertreatment system by operating the valvetrain in the second mode.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

The FIGURE is a schematic illustration of an engine assembly according to the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring now to the FIGURE, an exemplary engine assembly 10 is schematically illustrated. The engine assembly 10 may include an engine 12 and an exhaust aftertreatment system 14. The engine 12 may include an engine block 16 defining a plurality of cylinders 18, cylinder heads 20, 22, fuel injectors 24, an intake manifold 26, exhaust manifolds 28, 30, and a valvetrain assembly 32. While the present example shows a V-8 application, it is understood that the disclosure applies equally to various other engine configurations as well.

The valvetrain assembly 32 may include intake and exhaust camshafts 34, 36, intake and exhaust valves 38, 40, intake and exhaust cam phasers 42, 44, and rocker arm assemblies 45. The intake valves 38 may be in communication with the intake manifold 26 and the exhaust valves 40 may be in communication with the exhaust manifolds 28, 30. While the engine assembly 10 is illustrated as an overhead cam engine, it is understood that the present disclosure may be applicable to a variety of other engine configurations as well including cam-in-block engines. Further, while shown as including two valves per cylinder, the present disclosure applies equally to engines having more than two valves per cylinder. Additionally, the present disclosure applies equally to engine configurations having an inboard exhaust manifold and outboard intake manifolds.

The valvetrain assembly 32 may form a cylinder deactivation system and may be operable in full cylinder and cylinder deactivation modes. The full cylinder mode may include each of the cylinders 18 firing. The full cylinder mode may include actuation of each of the intake and exhaust valves 38, 40 as well as operation of each of the fuel injectors 24. The cylinder deactivation mode may include at least one of the cylinders 18 being in a deactivated state. The deactivated state may include one or both of the intake and exhaust valves 38, 40 for a given cylinder 18 remaining in a closed position and/or the fuel injector 24 for the given cylinder being in a non-injecting state for at least two consecutive crankshaft revolutions. For example, the rocker arm assemblies 45 associated with ones of cylinders 18 operable in a deactivated state may include a lost motion mechanism that prevents valve displacement during operation in the cylinder deactivation mode.

The exhaust aftertreatment system 14 may include a variety of devices that reduce an exhaust emissions level. The engine 12 may be a compression ignition engine and may operate on a hydrocarbon-based diesel fuel. By way of non-limiting example, the engine 12 may include a diesel engine and the exhaust aftertreatment system 14 may include a diesel particulate filter (DPF). A DPF may accumulate a particulate matter over time and may be regenerated periodically to remove the particulate matter. For example, regeneration may include raising an operating temperature of the DPF to oxidize the particulate matter. Regeneration may occur at temperatures greater than 570 degrees Celcius. The exhaust aftertreatment system 14 may alternatively or additionally include oxidation catalysts and/or NO_{X} reduction devices designed to remove nitrogen oxide (NO_{X}) emissions, such as selective catalytic reduction (SCR) catalysts and lean NO_{X} traps (LNT). A catalytic reaction may be initiated within these devices by increased exhaust gas temperatures.

Alternatively, the engine 12 may include a gasoline spark-ignited engine and the exhaust aftertreatment system 14 may include a catalyst that requires operation at a specific temperature (or light-off temperature) to function properly. For example, the catalyst may include a catalytic converter.

A temperature sensor 46 (or sensors) may be in communication with the exhaust aftertreatment system 14 and a control module 48 may be in communication with the engine 12 and the temperature sensor 46. The control module 48 may control operation of the valvetrain assembly 32 to adjust the operating temperature of the exhaust aftertreatment system 14. More specifically, the control module 48 may selectively actuate the valvetrain assembly 32 between the full cylinder and the cylinder deactivation modes. The control module 48 may additionally control the intake and exhaust cam phasers 42, 44 to adjust timing of the opening of the intake and exhaust valves 38, 40.

For example, the engine 12 may be operated in a first engine operating condition including operation in a first valvetrain mode. The first valvetrain mode may include normal engine operation where all cylinders are enabled and firing (non-deactivated mode). The temperature of the exhaust aftertreatment system 14 may be monitored by the control module 48 during the first engine operating condition. When the temperature is below a desired temperature, the engine 12 may transition to a second engine operating condition including a second valvetrain mode. The first and second engine operating conditions may be similar to one another, such as an idle condition for both. For example, if regeneration is needed while the engine 12 is idling or under a light load, the temperature of the exhaust aftertreatment system 14 may be raised by switching to the second valvetrain mode where an increased exhaust gas temperature is generated from operation of the engine 12 in the cylinder deactivation mode. Alternatively, during start-up conditions, the exhaust aftertreatment system 14 may be quickly heated to a desired temperature by operating the engine 12 in the second valvetrain mode.

Alternatively, the first and second engine operating conditions may be different from one another, such as a full load condition for the first engine operating condition and a light load condition for the second engine operating condition. The light load condition may include an engine idle condition. Operation of the engine 12 under a full or partial load condition may generally provide an acceptable exhaust gas temperature for operation of the exhaust aftertreatment system 14. When the engine 12 is transitioned to a light load condition, the typical exhaust gas temperature associated with the light load condition may be inadequate for operation of the exhaust aftertreatment system. Operating the engine 12 in the second valvetrain mode may raise the load on the functioning (non-deactivated) cylinders 18 to provide an acceptable exhaust gas temperature for operation of the exhaust aftertreatment system 14. For example, if a DPF regeneration event is initiated during the first engine operating condition and the engine 12 transitions to the second operating condition before regeneration is completed, the engine 12 may be operated in the second valvetrain mode to continue the regeneration event during the second engine operating condition.

The control module 48 may operate the valvetrain assembly 32 in the second valvetrain mode to increase or maintain the temperature of the exhaust aftertreatment device. For example, as indicated above, the second valvetrain mode may include the cylinder deactivation mode. The cylinder deactivation mode may include the pumping and firing of a fewer number of cylinders relative to the first valvetrain mode. Operation in the cylinder deactivation mode may increase the load on the firing cylinders, raising the exhaust gas temperature. The hotter exhaust gas may then heat the exhaust aftertreatment system 14. The exhaust valves 40 associated with the deactivated cylinders 18 may be maintained in a closed position during the cylinder deactivation mode. Maintaining the exhaust valves 40 in a closed position may prevent cooling of the hot exhaust gas from the firing cylinders 18 from the relatively cooler air from the non-firing cylinders 18. Once a desired temperature is achieved, the control module 48 may switch operation of the engine 12 back to the first valvetrain mode to prevent overheating of the exhaust aftertreatment system 14.

Operation of the engine 12 in the second valvetrain mode may additionally include adjusting the valve timing of the intake and exhaust valve opening through actuation of the intake and/or exhaust cam phasers 42, 44. Adjusting the valve timing may control an air flow into the engine 12, reducing or eliminating the need for a throttle. Adjusting the timing may provide an additional load on the engine 12 to increase an exhaust gas temperature, and therefore the temperature of the exhaust aftertreatment system 14.

What is claimed is:

1. A method comprising:
operating an engine in a first valvetrain mode during a first engine operating condition;
operating the engine in a second valvetrain mode different from the first valvetrain mode during a second engine operating condition; and
controlling a temperature of an exhaust aftertreatment component in communication with an exhaust gas from the engine during the second engine operating condition based on the second valvetrain mode.

2. The method of claim 1, wherein the second valvetrain mode includes a cylinder deactivation mode where a fewer number of cylinders are fired relative to the first valvetrain mode.

3. The method of claim 2, wherein the first and second engine operating conditions are the same and the controlling the temperature includes increasing an exhaust gas temperature based on an increased load on the firing cylinders during the second valvetrain mode relative to a load on the firing cylinders during the first valvetrain mode.

4. The method of claim 2, wherein the first and second engine operating conditions are the same and the operating the engine in the second valvetrain mode includes adjusting a valve timing relative to the first valvetrain mode.

5. The method of claim 4, wherein the adjusting the valve timing includes controlling an air flow into the engine.

6. The method of claim 4, wherein the adjusting the valve timing includes increasing a load on the engine.

7. The method of claim 1, wherein the operating the engine in the second valvetrain mode includes adjusting a valve timing relative to the first valvetrain mode.

8. The method of claim 1, wherein the controlling the temperature of the exhaust aftertreatment component includes increasing a temperature of an exhaust gas produced by the engine.

9. The method of claim 8, wherein the engine includes a diesel engine and the exhaust aftertreatment component includes a diesel particulate filter, the controlling the temperature of the exhaust aftertreatment component selectively providing regeneration of the diesel particulate filter.

10. The method of claim 8, wherein the engine includes a diesel engine and the exhaust aftertreatment component includes a nitrogen oxide reduction device, the controlling the temperature of the exhaust aftertreatment component selectively activating a catalytic reaction within the nitrogen oxide reduction device.

11. The method of claim 8, wherein the engine is a gasoline engine and the exhaust aftertreatment component is a catalyst, the controlling the temperature of the exhaust aftertreatment component selectively providing a light-off condition for the catalyst.

12. The method of claim 1, wherein the second valvetrain mode provides a greater engine load than the first valvetrain mode.

13. The method of claim 12, wherein the second engine operating condition includes an engine idle condition.

14. The method of claim 1, wherein the first and second engine operating conditions are different from one another.

15. An engine assembly comprising:
an engine including a valvetrain operable in first and second modes;
an exhaust aftertreatment system in communication with an exhaust gas provided by the engine; and
a control module in communication with the engine to control a temperature of the exhaust aftertreatment system by operating the valvetrain in the second mode.

16. The engine assembly of claim 15, wherein the engine defines cylinders and the valvetrain includes a cylinder deactivation system operable to adjust a number of firing cylinders in the engine, the second mode including a cylinder deactivation mode where a fewer number of cylinders are fired relative to the first valvetrain mode.

17. The engine assembly of claim 16, wherein the engine includes a camshaft and a cam phaser and the valvetrain includes intake and exhaust valves in communication with the cylinders, the cam phaser adjusting a timing of opening the intake and exhaust valves in the second mode relative to the first mode.

18. The engine assembly of claim 15, wherein the engine includes a diesel engine and the exhaust aftertreatment system includes a diesel particulate filter.

19. The engine assembly of claim 15, wherein the engine includes a diesel engine and the exhaust aftertreatment system includes a nitrogen oxide reduction device.

20. The engine assembly of claim 14, wherein the engine includes a gasoline engine and the exhaust aftertreatment system includes a catalyst.
